(19) United States
(12) Patent Application Publication
(10) Pub. No.: US 2026/0318346 A1
(43) Pub. Date: Oct. 15, 2026

(54) INSULATING BOLT, BATTERY PACK INCLUDING THE SAME, AND VEHICLE INCLUDING BATTERY PACK

(71) Applicant: LG Energy Solution, Ltd., Seoul (KR)

(72) Inventor: Tae-Hee Kim, Daejeon (KR)

(21) Appl. No.: 19/543,249

(22) Filed: Feb. 18, 2026

(30) Foreign Application Priority Data
Mar. 12, 2025 (KR) 10-2025-0032008

(51) Int. Cl. F16B 33/00; F16B 23/00; H01M 50/262

(52) U.S. Cl. CPC F16B 33/004; F16B 23/0038; H01M 50/262; H01M 2220/20

(57) ABSTRACT

An insulating bolt according to one embodiment of the present disclosure is an insulating bolt for use in a battery pack, including: a fastening member that is fastened to a target object and having a first coupling portion for coupling with a first tool; and a protective member that surrounds a part of the fastening member and having a second coupling portion for coupling with a second tool, at least a part of the protective member being made of an insulating material.

### CROSS-REFERENCE TO RELATED APPLICATIONS

This application is based on and claims priority from Korean Patent Application No. 10-2025-0032008 filed on Mar. 12, 2025, with the Korean Intellectual Property Office, the disclosure of which is incorporated herein in its entirety by reference.

### TECHNICAL FIELD

The present disclosure relates to an insulating bolt, a battery pack including the insulating bolt, and a vehicle including the battery pack.

### BACKGROUND

In general, a secondary battery refers to a battery capable of repeated charging and discharging, such as a lithium-ion battery, a lithium polymer battery, a nickel-cadmium battery, a nickel-metal hydride battery, or a nickel-zinc battery. A battery cell, which corresponds to the most basic form of a secondary battery, may provide an output voltage of approximately 2.5 V to 4.2 V.

Recently, as such battery cells have been applied to devices requiring a high output voltage and a large charge capacity, such as electric vehicles and energy storage systems (ESSs), a battery module configured by connecting a plurality of battery cells in series, in parallel, or in a combination of series and parallel, and a battery pack configured by connecting such battery modules in series, in parallel, or in a combination of series and parallel, have been widely used.

### SUMMARY

The present disclosure provides an insulating bolt that enables electrical insulation while allowing easy release of the fastened bolt, a battery pack including the insulating bolt, and a vehicle including the battery pack.

Further, the present disclosure provides an insulating bolt that facilitates repair or replacement of components inside a battery pack upon release of the fastened bolt, a battery pack including the insulating bolt, and a vehicle including the battery pack.

Furthermore, the present disclosure provides an insulating bolt that may prevent or suppress the occurrence of flames through electrical insulation of the bolt, a battery pack including the insulating bolt, and a vehicle including the battery pack.

However, the technical issues to be addressed by the present disclosure are not limited to those described above, and other issues not mentioned herein will be clearly understood by those skilled in the art from the following description of the present disclosure.

According to one aspect of the present disclosure, there may be provided an insulating bolt for use in a battery pack, the insulating bolt including: a fastening member that is fastened to a target object and having a first coupling portion for coupling with a first tool; and a protective member that surrounds a part of the fastening member and having a second coupling portion for coupling with a second tool, at least a part of the protective member being made of an insulating material.

In one embodiment, the fastening member may be made of a metallic material.

In one embodiment, the fastening member may include: a head portion in which the first coupling portion for coupling with the first tool is formed; and a leg portion extending from the head portion and having a thread formed thereon.

In one embodiment, the first coupling portion formed in the head portion of the fastening member may be formed as a hexagonal recess.

In one embodiment, the protective member may include a fastening member-protecting portion into which a part of the fastening member is inserted; and a tooling portion located on an opposite side of the fastening member-protecting portion and including the second coupling portion for coupling with the second tool.

In one embodiment, a part of the fastening member may be formed in a hexagonal shape, and the fastening member-protecting portion of the protective member may also be formed in a hexagonal shape.

In one embodiment, the second coupling portion formed in the tooling portion of the protective member may be formed as a hexagonal recess having a size larger than that of the first coupling portion formed in the head portion of the fastening member.

In one embodiment, the tooling portion may include: a first surface at a preset position; a second surface recessed downward from the first surface; and a third surface extending from the second surface and formed parallel to the first surface, and the third surface may have a through-hole having a size and shape corresponding to the first coupling portion formed in the head portion of the fastening member.

In one embodiment, the second coupling portion may be formed on the second surface formed in the tooling portion of the protective member, and the second tool may come into contact with the second surface.

In one embodiment, the second surface formed on the tooling portion of the protective member may be formed in a hexagonal shape.

In one embodiment, an outer surface connected to the first surface may be formed in a shape corresponding to a shape of a third tool such that the third tool is coupled to the outer surface connected to the first surface formed on the tooling portion of the protective member.

In one embodiment, the outer surface connected to the first surface formed on the tooling portion of the protective member may be formed in a hexagonal shape.

In one embodiment, the insulating bolt may further include an insulating cover member coupled to the second surface formed on the tooling portion of the protective member.

In one embodiment, the insulating cover member may include: a main body portion formed in a shape corresponding to the second surface formed on the tooling portion of the protective member and coupled to the second surface; and an insertion portion formed in a shape corresponding to the through-hole formed in the third surface of the protective member and inserted into the through-hole.

In one embodiment, the insertion portion of the insulating cover member may be inserted up to the first coupling portion formed in the head portion of the fastening member.

In one embodiment, the first coupling portion and the second coupling portion may be respectively designed such that the first tool and the second tool are selectively coupled thereto.

Meanwhile, according to another aspect of the present disclosure, a battery pack including the above-described insulating bolt may be provided, and a vehicle including the above-described battery pack may also be provided.

The embodiments of the present disclosure provide the effects of enabling electrical insulation while allowing an easy release of a fastened bolt.

Further, the embodiments of the present disclosure provide the effects of facilitating repair or replacement of components inside the battery pack upon release of a fastened bolt.

Furthermore, the embodiments of the present disclosure provide the effects of preventing or suppressing the occurrence of flames through electrical insulation of a bolt.

However, the effects obtainable through the present disclosure are not limited to those described above, and other technical effects not mentioned herein may be clearly understood by those skilled in the art from the following description of the disclosure.

### BRIEF DESCRIPTION OF THE DRAWINGS

The following drawings attached hereto illustrate embodiments of the present disclosure and serve to further understand the technical idea of the present disclosure together with the content of the disclosure described above. Therefore, the present disclosure should not be construed as being limited to the matters illustrated in the drawings.

FIG. 1 is a schematic assembled perspective view of an insulating bolt according to a first embodiment of the present disclosure.

FIG. 2 is a schematic exploded perspective view of the insulating bolt according to the first embodiment of the present disclosure.

FIG. 3 is a cross-sectional view of the insulating bolt according to the first embodiment of the present disclosure.

FIG. 4 is a perspective view illustrating the lower side of a protective member in the insulating bolt according to the first embodiment of the present disclosure.

FIG. 5 is a view illustrating a state where a first tool is separated from a first coupling portion in the insulating bolt according to the first embodiment of the present disclosure.

FIG. 6 is a view illustrating a state where the first tool is coupled to the first coupling portion in the insulating bolt according to the first embodiment of the present disclosure.

FIG. 7 is a view illustrating a state where a second tool is separated from a second coupling portion in the insulating bolt according to the first embodiment of the present disclosure.

FIG. 8 is a view illustrating a state where the second tool is coupled to the second coupling portion in the insulating bolt according to the first embodiment of the present disclosure.

FIG. 9 is a view illustrating a state where a third tool is separated from an outer surface connected to a first surface of a tooling portion in the insulating bolt according to the first embodiment of the present disclosure.

FIG. 10 is a view illustrating a state where the third tool is coupled to the outer surface connected to the first surface of the tooling portion in the insulating bolt according to the first embodiment of the present disclosure.

FIG. 11 is a schematic assembled perspective view of the insulating bolt according to a second embodiment of the present disclosure.

FIG. 12 is a schematic exploded perspective view of the insulating bolt according to the second embodiment of the present disclosure.

FIG. 13 is a cross-sectional view of the insulating bolt according to the second embodiment of the present disclosure.

FIG. 14 is a perspective view of an insulating cover member according to the second embodiment of the present disclosure.

FIG. 15 is a view of a battery pack including the insulating bolt according to the respective embodiments of the present disclosure.

FIG. 16 is a view illustrating a vehicle including the battery pack of FIG. 15.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Hereinafter, embodiments of the present disclosure will be described in detail with reference to the accompanying drawings. The terms or words used in this specification and the claims should not be interpreted as being limited to their usual or dictionary meanings, but should be interpreted as having meanings and concepts that are consistent with the technical ideas of the present disclosure, based on the principles that the inventors may appropriately define the concepts of the terms to describe their invention in the best way possible. Therefore, since the embodiments described in this specification and the configurations illustrated in the drawings are merely the most preferred embodiment of the present disclosure and do not represent all of the technical ideas of the present disclosure, it should be understood that various equivalents and modifications that may replace them at the time of filing may exist.

In the drawings, the sizes of each component or a specific portion constituting the component is exaggerated, omitted, or schematically illustrated for convenience and clarity of description. Accordingly, the size of each component does not entirely reflect the actual size thereof. When it is determined that a detailed description of related well-known functions or configurations may unnecessarily obscure the gist of the present disclosure, such description will be omitted.

As used herein, the terms “coupled” or “connected” include not only a case where one member is directly coupled to or directly connected to another member, but also a case where one member is indirectly coupled to or indirectly connected to another member through an intermediate member.

Meanwhile, content that is common to portions described in one embodiment of the present disclosure may also be applied to other embodiments. For example, in the second embodiment, content that is common to portions described in a first embodiment is replaced with the description of the first embodiment, and such common content is also applicable to the second embodiment. In addition, content applicable to the first embodiment among portions described in the second embodiment may be applied to the first embodiment. Then, the same applies to other embodiments as well.

As used herein, the term “release” refers to release of a fastened bolt, that is, unfastening a tightened bolt.

Lithium secondary batteries are currently in the spotlight due to advantages such as a high operating voltage and an extremely high energy density. However, since lithium secondary batteries use an organic electrolyte, overcharging of a lithium secondary battery may cause overcurrent and overheating, which, in severe cases, may lead to explosions or fires caused by ignition.

Then, as fire accidents involving secondary batteries have increased, the necessity for electrical insulation of components has grown, and accordingly, conductive components are being replaced with non-conductive components that having electrical insulating properties.

For example, the bolts used to fasten the components at various positions in a battery pack may also be formed of non-conductive components having insulating properties such as plastic. However, the bolts formed of non-conductive components such as plastic tend to be easily damaged during a bolt fastening process or a release process of a fastened bolt.

Then, for example, when a fastened bolt needs to be released to repair or replace the components inside a battery pack, the damages to a bolt head or another portion of the bolt fastening the components may make it difficult to release the fastened bolt, thereby making repair or replacement of the components difficult or impossible.

In consideration of the above-described issues, the present disclosure provides a bolt that enables electrical insulation while allowing an easy release of the fastened bolt, facilitates repair or replacement of the components inside a battery pack upon release of the fastened bolt, and may prevent or suppress the occurrence of flames through electrical insulation.

An insulating bolt according to one embodiment of the present disclosure may be used, for example, in a battery pack of a secondary battery. For example, the insulating bolt is used to fasten various electrical components included inside the battery pack. Since the electrical components inside the battery pack may be electrically connected to each other, and thus, may pose a risk of fire, it is advantageous to use the insulating bolt as a bolt for fastening the electrical components inside the battery pack in order to prevent or suppress such a risk. Accordingly, the insulating bolt according to one embodiment of the present disclosure is configured to selectively have insulating properties at necessary portions and fasten the electrical components inside the battery pack, thereby preventing or suppressing the occurrence of fire inside the battery pack.

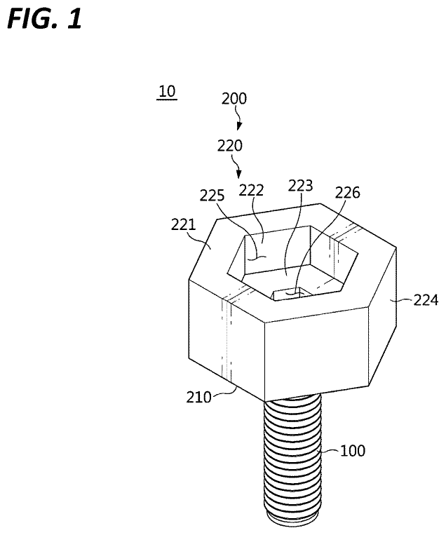

Hereinafter, an insulating bolt 10 according to one embodiment of the present disclosure will be described with selective reference to FIGS. 1 to 10.

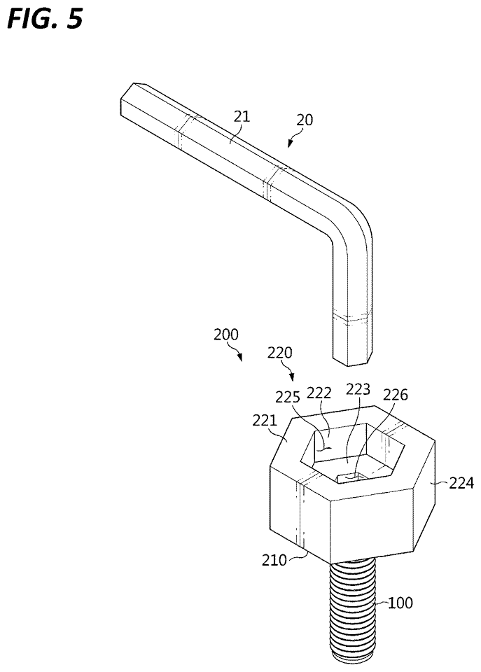

The insulating bolt 10 according to one embodiment of the present disclosure includes a fastening member 100 and a protective member 200. A first coupling portion 111 for coupling with a first tool 21 (see, e.g., FIG. 5) is formed in the fastening member 100. Then, the fastening member 100 is coupled to a fastening target object (not illustrated).

The fastening target object includes various articles fastened by the insulating bolt 10, and may include, for example, various electrical components such as a busbar and a battery cell provided inside a battery pack. The insulating bolt 10 according to one embodiment of the present disclosure fastens and fixes various electrically connected electrical components, for example, a busbar and/or a battery cell. However, the target object is not limited to the busbar or the battery cell.

The first tool 21 may be any one of various tools 20 capable of fastening the fastening member 100 to the target object. For example, the first coupling portion 111 may be formed as a hexagonal recess, and when the first coupling portion 111 is a hexagonal recess, the first tool 21 may be a hex wrench having a size corresponding to the hexagonal recess serving as the first coupling portion 111. However, the first tool 21 is not limited to the hex wrench.

The fastening member 100 may be made of a metallic material in consideration of rigidity. However, the material of the fastening member 100 is not limited to a metal, and the fastening member 100 may be made of another material, for example, reinforced plastic, as long as sufficient rigidity is provided.

The fastening member 100 also has a release function when the protective member 200 is damaged. A detailed description thereof will be provided later.

The fastening member 100 may include a head portion 110 and a leg portion 120.

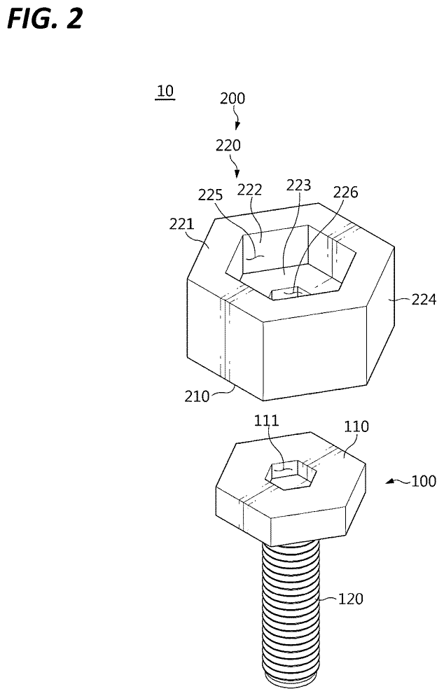

The first coupling portion 111 for coupling with the first tool 21 may be formed in the head portion 110 of the fastening member 100. Here, the first coupling portion 111 of the head portion 110 may be formed in various ways, and for example, may be formed as a hexagonal recess, as illustrated in FIG. 2. Then, the first tool 21 may be configured as a hex wrench that may be coupled to the first coupling portion 111, as illustrated in FIG. 5.

The first coupling portion 111 formed in the head portion 110 of the fastening member 100 may have a polygonal shape other than a hexagonal shape, and in this case, the first tool 21 may have a shape corresponding to the polygonal shape of the first coupling portion 111 so as to be coupled to the first coupling portion 111. However, hereinafter, for the convenience of description, a case will be mainly described where the first coupling portion 111 is a hexagonal recess and the first tool 21 is a hex wrench that may be inserted into the hexagonal recess serving as the first coupling portion 111 to fasten or release the fastening member 100.

The head portion 110 may be made of various kinds of metals, but is not limited thereto, and as described above, may be made of a material other than a metal as long as sufficient rigidity is provided.

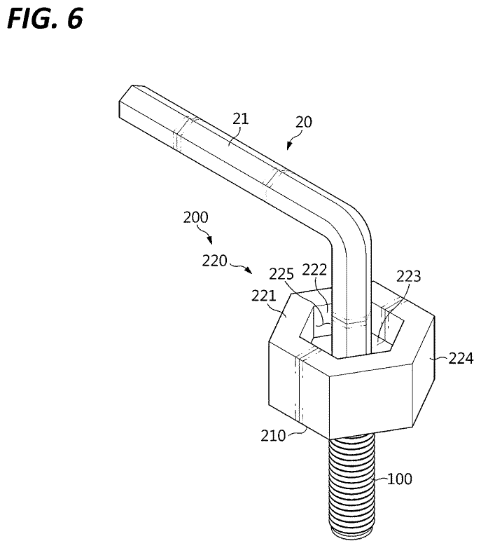

The first tool 21, which is a hex wrench, is coupled to the first coupling portion 111, which is a hexagonal recess formed in the head portion 110 of the fastening member 100 (see, e.g., FIG. 6). Here, when an operator rotates the hex wrench in a first direction (e.g., clockwise), the fastening member 100 is fastened to the target object, and when the operator rotates the hex wrench in a second direction (e.g., counterclockwise) opposite to the first direction, the fastening member 100 is released from the target object.

The leg portion 120 of the fastening member 100 extends from the head portion 110. Then, screw threads may be formed in the leg portion 120. For example, when the first tool 21 is coupled to the first coupling portion 111 of the head portion 110 and is rotated, the leg portion 120 may be coupled to the target object by a threaded fastening method.

As in the head portion 110, the leg portion 120 may be made of various kinds of metals, but is not limited thereto.

The protective member 200 of the insulating bolt 10 is made of an electrically insulating material and configured to surround a part of the fastening member 100, for example, the head portion 110 of the fastening member 100. Since the fastening member 100 has electrical conductivity when it is made of a metallic material, the protective member 200 made of an electrically insulating material is configured to surround the fastening member 100 so as to block the electrical conductivity of the fastening member 100.

The protective member 200 may be made of various materials having electrical insulation properties, such as, for example, various plastics, but the material thereof is not limited thereto.

According to one embodiment, the protective member 200 may be manufactured to surround the fastening member 100 by an injection molding of plastic, but the manufacturing method is not limited to the injection molding.

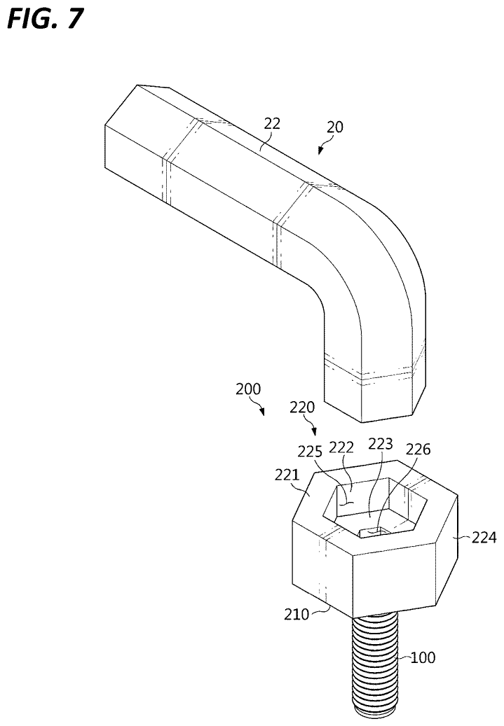

The protective member 200 is made of an electrically insulating material to protect the fastening member 100 and block the electrical conductivity of the fastening member 100, and is further provided with a second coupling portion 225 for coupling with a second tool 22, thereby providing a tooling function (see, e.g., FIG. 7).

In the meantime, instead of the entire protective member 200 being made of an electrically insulating material, only a portion of the protective member 200 may be made of an electrically insulating material, and the remaining portion may be made of another material, for example, a metallic material such as that of the fastening member 100. For example, an inner surface of a through-hole 226 formed in the protective member 200, which comes into contact with the head portion 110 of the fastening member 100, may be made of a metallic material such as that of the fastening member 100, and the remaining portion may be made of plastic. In this way, for example, the adhesion between the fastening member 100 and the protective member 200 may be enhanced.

The insulating bolt 10 according to the first embodiment of the present disclosure is basically designed to be fastened to the target object via the protective member 200. Then, when the protective member 200 is made of, for example, a plastic material, it may be damaged during a fastening process or a release process. When the protective member 200 is damaged and may not be used, the insulating bolt 10 fastened to the target object via the fastening member 100 may be released. This will be described in detail below.

The protective member 200 may include a fastening member-protecting portion 210 and a tooling portion 220.

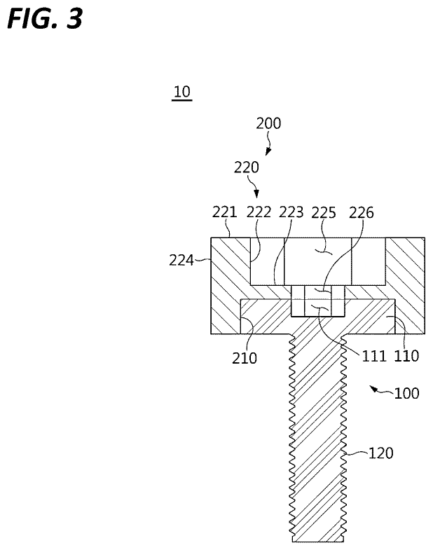

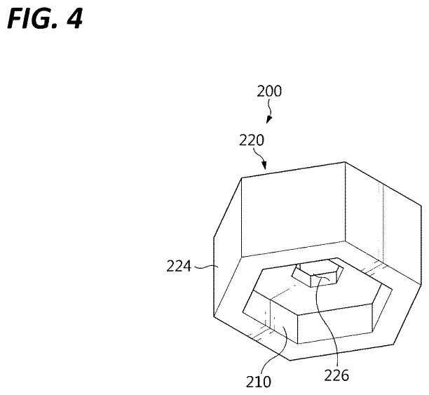

A part of the fastening member 100 is inserted into the fastening member-protecting portion 210 (see, e.g., FIG. 3). When a part of the fastening member 100, for example, the head portion 110 of the fastening member 100, is formed in a hexagonal shape, the fastening member-protecting portion 210 may also be formed in a hexagonal shape (see, e.g., FIG. 4). However, the shape of the head portion 110 of the fastening member 100 and the shape of the fastening member-protecting portion 210 are not limited to a hexagonal shape.

The tooling portion 220 of the protective member 200 is positioned on an opposite side of the fastening member-protecting portion 210. Then, the second coupling portion 225 for coupling with the second tool 22 (see, e.g., FIG. 7) is formed in the tooling portion 220.

The second coupling portion 225 formed in the tooling portion 220 may be formed in various ways, and for example, may be formed as a hexagonal recess, as illustrated in FIG. 2. Then, the second tool 22 may be configured as a hex wrench that may be coupled to the second coupling portion 225 (see, e.g., FIG. 5).

In the meantime, the second coupling portion 225 may be formed in a polygonal shape other than a hexagonal shape, and in this case, the second tool 22 may have a shape corresponding to the polygonal shape of the second coupling portion 225 so as to be coupled to the second coupling portion 225. However, hereinafter, for convenience of description, a case where the second coupling portion 225 is a hexagonal recess and the second tool 22 is a hex wrench that may be inserted into the hexagonal recess serving as the second coupling portion 225 to fasten or release the fastening member 100 will be mainly described.

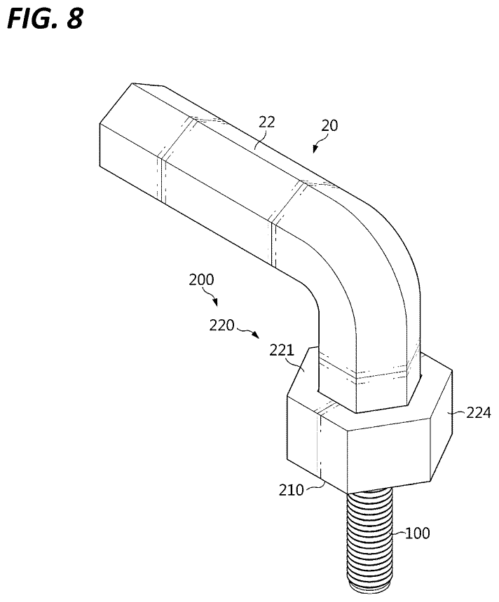

The second tool 22, which is a hex wrench, is coupled to the second coupling portion 225, which is a hexagonal recess formed in the tooling portion 220 of the protective member 200 (see, e.g., FIG. 8). Here, when the operator rotates the hex wrench in a first direction (e.g., clockwise), the fastening member 100 is fastened to the target object, and when the operator rotates the hex wrench in a second direction (e.g., counterclockwise) opposite to the first direction, the fastening member 100 is released from the target object.

According to one embodiment, the second coupling portion 225 formed in the tooling portion 220 of the protective member 200 may be formed as a hexagonal recess having a size larger than that of the first coupling portion 111. Thus, the second tool 22 may be a hex wrench having a larger size than the first tool 21.

The tooling portion 220 of the protective member 200 may include a first surface 221, a second surface 222, and a third surface 223.

The first surface 221 of the tooling portion 220 is formed at a preset position. For example, in FIG. 1, the upper side of the tooling portion 220 corresponds to the first surface 221. Then, the second surface 222 is recessed downward from the first surface 221. Then, the third surface 223 extends from the second surface 222 and is formed parallel to the first surface 221.

Here, the second surface 222 and the third surface 223 may be formed in a hexagonal shape, and in this case, the second coupling portion 225 is formed on the second surface 222, and the second tool 22 comes into contact with the second surface 222. The second tool 22 may also come into contact with the third surface 223 as well.

The through-hole 226 having a size and shape corresponding to the first coupling portion 111 of the fastening member 100 is formed in the third surface 223 of the tooling portion 220, and the first tool 21 passes through the through-hole 226 of the third surface 223 formed in the tooling portion 220 of the protective member 200 and is coupled to the first coupling portion 111 of the head portion 110 of the fastening member 100.

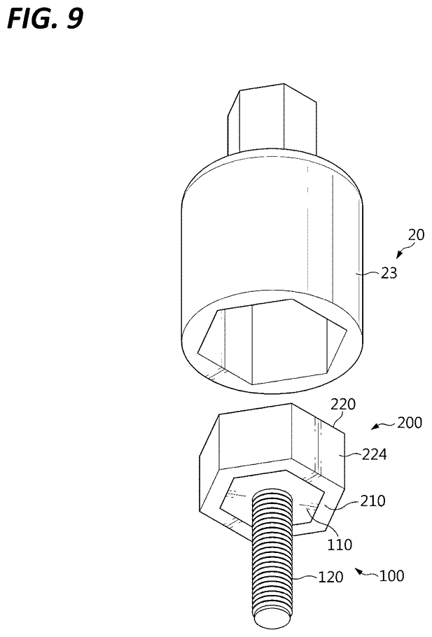

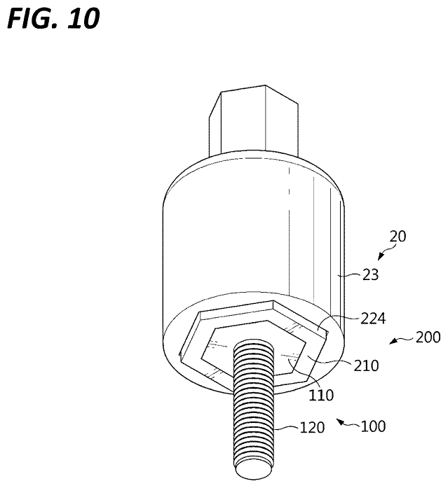

Referring to FIGS. 9 and 10, a third tool 23 may be coupled to an outer surface 224 connected to the first surface 221 of the tooling portion 220 of the protective member 200. To this end, the outer surface 224 connected to the first surface 221 of the tooling portion 220 may be formed in a shape corresponding to the shape of the third tool 23. For example, when the third tool 23 is formed in a hexagonal shape, the outer surface 224 connected to the first surface 221 of the tooling portion 220 may also be formed in a hexagonal shape.

The third tool 23 may be formed differently from both the first tool 21 and the second tool 22. For example, the first tool 21 is inserted into the hexagonal recess serving as the first coupling portion 111 and the second tool 22 is also inserted into the hexagonal recess serving as the second coupling portion 225, whereas the third tool 23 has a hexagonal recess formed therein, and the tooling portion 220 of the protective member 200 is inserted into the hexagonal recess formed in the third tool 23. However, the third tool 23 is not limited thereto.

The insulating bolt 10 according to the first embodiment of the present disclosure may use all three types of tools 20, for example, the first tool 21, the second tool 22, and the third tool 23.

In the meantime, the insulating bolt 10 may be fastened to the target object using the first tool 21, but the insulating bolt 10 is typically fastened to the target object using the second tool 22, or using the third tool 23.

In the meantime, after the insulating bolt 10 is fastened to the target object, it may be necessary to release the insulating bolt 10 fastened to the target object in order to replace or repair the target object. In this case, typically, the operator releases the insulating bolt 10 fastened to the target object using the second tool 22 or the third tool 23, and accordingly performs replacement or repair of the target object.

However, when the protective member 200 of the insulating bolt 10 is made of an insulating material having low rigidity such as plastic, the protective member 200 may be damaged due to various causes. For example, when the protective member 200 is damaged while the insulating bolt 10 is tightly fastened to the target object, releasing the fastening member 100 from the target object may be difficult or even impossible when the first coupling portion 111 is not formed in the head portion 110 of the fastening member 100.

In preparation for such a case, the first coupling portion 111 for coupling with the first tool 21 is formed in the head portion 110 of the fastening member 100, and as described above, when the protective member 200 is damaged, the operator may couple the first tool 21 to the first coupling portion 111 of the head portion 110 of the fastening member 100 to remove the fastening member 100 from the target object.

The insulating bolt 10 according to the first embodiment of the present disclosure enables electrical insulation, and also allows an easy release of the fastened insulating bolt 10 (e.g., easy release of the fastening member 100 even when the protective member 200 is damaged). In addition, the insulating bolt 10 facilitates repair or replacement of components inside a battery pack upon release of the fastened bolt, and may prevent or suppress the occurrence of flames through electrical insulation of the bolt.

In addition to the advantage in that the insulating bolt 10 according to the first embodiment of the present disclosure may be fastened to the target object using all three types of tools 20, the insulating bolt 10 also has an advantage in that it may be easily removed from the target object even when the protective member 200 of the insulating bolt 10 is damaged.

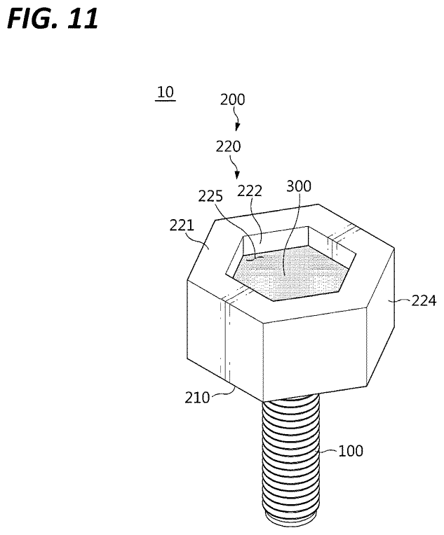

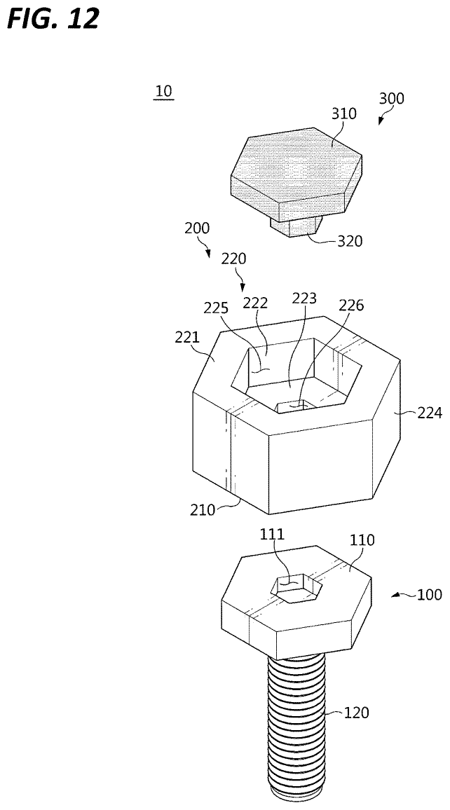

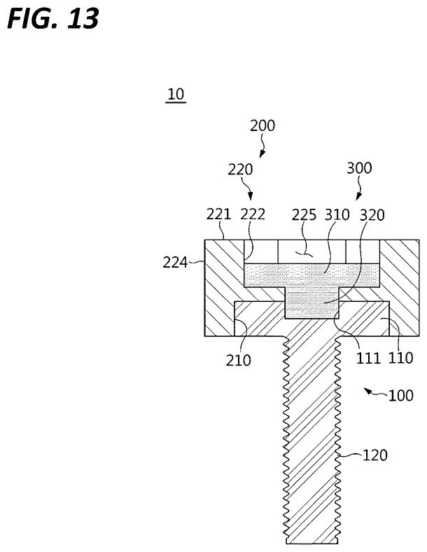

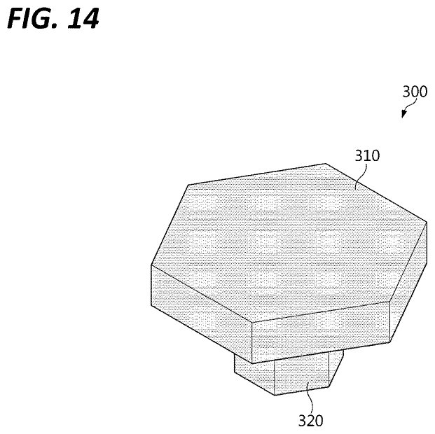

Hereinafter, the insulating bolt 10 according to a second embodiment of the present disclosure will be described with selective reference to FIGS. 11 to 14.

The second embodiment differs structurally from the first embodiment in that an insulating cover member 300 is coupled to the protective member 200 in the second embodiment so as to completely electrically insulate the fastening member 100. In consideration of such structural differences, the insulating bolt 10 of the first embodiment may be used as needed, or alternatively, the insulating bolt 10 of the second embodiment may be used.

The insulating cover member 300 of the insulating bolt 10 according to the second embodiment may be coupled to the second surface 222 of the tooling portion 220 of the protective member 200. The insulating cover member 300 is made of various kinds of insulating materials, and may be made of, for example, silicone, but is not limited thereto.

The insulating cover member 300 of the insulating bolt 10 according to the second embodiment may include a main body portion 310 and an insertion portion 320. The main body portion 310 is formed in a shape corresponding to the second surface 222 formed on the tooling portion 220 of the protective member 200 and is coupled to the second surface 222. Then, the insertion portion 320 of the insulating cover member 300 is formed in a shape corresponding to the through-hole 226 formed in the third surface 223 of the tooling portion 220 of the protective member 200 and is inserted into the through-hole 226.

The insertion portion 320 of the insulating cover member 300 may be inserted up to the first coupling portion 111 formed in the head portion 110 of the fastening member 100.

In this way, the insulating cover member 300 entirely covers the fastening member 100 from above, thereby electrically insulating the fastening member 100.

Then, in a state where the insulating cover member 300 is coupled to the protective member 200 (see, e.g., FIG. 11), the second tool 22 may be rotated in contact with the second surface 222, thereby fastening or releasing the fastening member 100. As such, even in a state where the insulating cover member 300 is coupled to the protective member 200, the operator may fasten the insulating bolt 10 to the target object, or may release the insulating bolt 10 fastened to the target object.

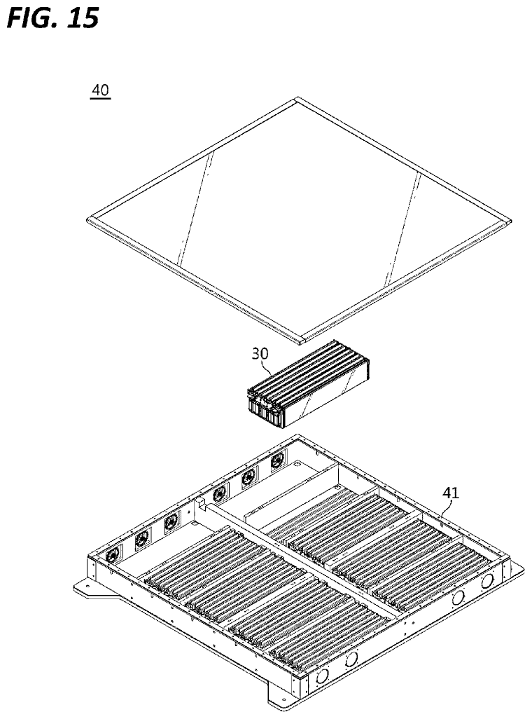

FIG. 15 is a view of a battery pack including the insulating bolt 10 according to each embodiment of the present disclosure.

Referring to FIG. 15, a battery pack 40 according to one embodiment of the present disclosure may include one or more insulating bolts 10 according to the respective embodiments of the present disclosure described above.

In addition, the battery pack 40 may include various types of battery cells, for example, pouch-type battery cells, cylindrical battery cells, or prismatic battery cells.

Then, the battery pack 40 may further include a pack case 41 and various devices for controlling charging and discharging of the battery cells, such as a battery management system (BMS), a current sensor, and a fuse.

Here, when the battery pack 40 includes pouch-type battery cells 30, the pouch-type battery cells 30 may be directly accommodated in the pack case 41, as illustrated in FIG. 15. Alternatively, although not illustrated in the drawings, the pouch-type battery cells may be accommodated in a module case of a battery module, and the battery module accommodating the pouch-type battery cells may be accommodated in the pack case 41.

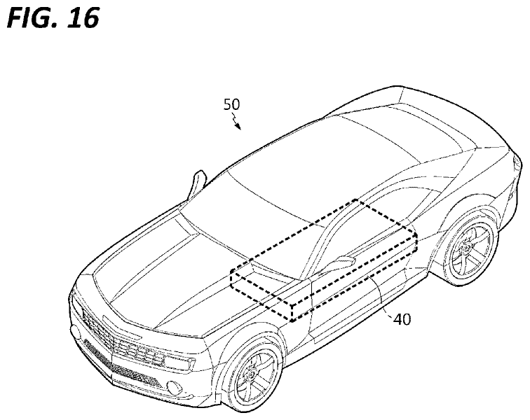

FIG. 16 is a view illustrating a vehicle including the battery pack of FIG. 15.

Referring to FIG. 16, a vehicle 50 according to one embodiment of the present disclosure may include one or more battery packs 40 according to the respective embodiments of the present disclosure described above. Here, the battery pack 40 may include one or more insulating bolts 10 according to the respective embodiments of the present disclosure described above.

Here, the vehicle 50 is, for example, any one of various vehicles configured to use electricity, such as an electric vehicle or a hybrid vehicle.

In the present disclosure, it will be apparent to those skilled in the art that, when terms such as upper, lower, left, and right are used, these terms are merely for convenience of description and may vary depending on factors such as the position of a target object and the position of an observer.

While the present disclosure has been described with reference to the limited embodiments and drawings, the present disclosure is not limited thereto, and various modifications and changes may be made by those skilled in the art of the present disclosure within the technical idea of the present disclosure and the scope equivalent to the claims set forth below. Therefore, the foregoing embodiments should be considered from the descriptive viewpoint, rather than from the limiting viewpoint. That is, the essential scope of the technical idea of the present disclosure may be found in the claims attached herewith, and any differences that fall under the equivalent scope to the present disclosure should be construed as being included in the present disclosure.

What is claimed is:

1. An insulating bolt for use in a battery pack, the insulating bolt comprising:
a fastener configured to be fastened to a target object and including a first coupling portion for coupling with a first tool; and
a protector configured to surround a portion of the fastener and including a second coupling portion for coupling with a second tool, at least a portion of the protector being made of an insulating material.

2. The insulating bolt according to claim 1, wherein the fastener is made of a metallic material.

3. The insulating bolt according to claim 2, wherein the fastener includes:
a head portion in which the first coupling portion for coupling with the first tool is formed; and
a leg portion extending from the head portion and having a thread formed thereon.

4. The insulating bolt according to claim 3, wherein the first coupling portion formed in the head portion of the fastener is formed as a hexagonal recess.

5. The insulating bolt according to claim 1, wherein the protector includes:
a fastener-protecting portion into which a portion of the fastener is inserted; and
a tooling portion located on an opposite side of the fastener-protecting portion and including the second coupling portion for coupling with the second tool.

6. The insulating bolt according to claim 5, wherein
a portion of the fastener is formed in a hexagonal shape, and
the fastener-protecting portion of the protector is formed in a hexagonal shape.

7. The insulating bolt according to claim 5, wherein the second coupling portion formed in the tooling portion of the protector is formed as a hexagonal recess having a size larger than that of the first coupling portion formed in the head portion of the fastener.

8. The insulating bolt according to claim 5, wherein the tooling portion includes:
a first surface at a preset position;
a second surface recessed downward from the first surface; and
a third surface extending from the second surface and formed parallel to the first surface, and
wherein the third surface has a through-hole having a size and a shape corresponding to the first coupling portion formed in the head portion of the fastener.

9. The insulating bolt according to claim 8, wherein the second coupling portion is formed on the second surface formed in the tooling portion of the protector, and the second tool comes into contact with the second surface.

10. The insulating bolt according to claim 8, wherein the second surface formed on the tooling portion of the protector is formed in a hexagonal shape.

11. The insulating bolt according to claim 8, wherein an outer surface connected to the first surface is formed in a shape corresponding to a shape of a third tool such that the third tool is coupled to the outer surface connected to the first surface formed on the tooling portion of the protector.

12. The insulating bolt according to claim 11, wherein the outer surface connected to the first surface formed on the tooling portion of the protector is formed in a hexagonal shape.

13. The insulating bolt according to claim 8, wherein the insulating bolt further includes an insulating cover coupled to the second surface formed on the tooling portion of the protector.

14. The insulating bolt according to claim 13, wherein the insulating cover includes:
a main body portion formed in a shape corresponding to the second surface formed on the tooling portion of the protector and coupled to the second surface; and
an insertion portion formed in a shape corresponding to the through-hole formed in the third surface of the protector and inserted into the through-hole.

15. The insulating bolt according to claim 14, wherein the insertion portion of the insulating cover member is inserted up to the first coupling portion formed in the head portion of the fastener.

16. The insulating bolt according to claim 1, wherein the first coupling portion and the second coupling portion are respectively configured such that the first tool and the second tool are selectively coupled thereto.

17. A battery pack comprising the insulating bolt according to claim 1.

18. A vehicle comprising the battery pack according to claim 17.
